(19) United States
(12) Patent Application Publication
(10) Pub. No.: US 2009/0056438 A1
(43) Pub. Date: Mar. 5, 2009

(54) Gage Cock Ball Valve

(76) Inventors: Richard C. Hughes, Santa Fe, TX (US); Melvin O. Castillo, Santa Fe, TX (US)

Correspondence Address: WILSON DANIEL SWAYZE, JR., 3804 CLEARWATER CT., PLANO, TX, 75025, US

(21) Appl. No.: 11/848,257

(22) Filed: Aug. 31, 2007

(51) Int. Cl. G01F 23/02

(52) U.S. Cl. 73/323

(57) ABSTRACT

An apparatus for measuring the level of fluid in a vessel including a sight glass for showing the level of the fluid and a valve which includes a ball valve passageway having a ball check valve, a bypass passageway for bypassing the ball check valve and a rotatable passageway for selecting the ball valve passageway or the bypass passageway.

### TECHNICAL FIELD

The present invention relates to devices and methods for valves for controlling the fluid which flows through sight gages and more particularly to a valve with the bypass passageway for a safety sight gauge for visually inspecting liquid level or presence in vessels and sight flow monitoring for piping systems, reactors and the like.

### BACKGROUND ART

Liquid sight indicators are used as liquid level gauges for vessel inventory estimation and sight flow monitors for piping system flow indication (bull's eye), or as observation sites for process equipment such as reactors, heaters, storage vessels and the like. Sight gauges are typically externally mounted on a vessel or pipe and connected between two mounting blocks attached within the range of liquid movement to indicate the presence and/or level of liquid therein. Gauges for visual indication employ transparent tubular conduits of an inert substance such as glass mounted between the mounting blocks. Breakage of the glass tube is a concern.

Many inventors have described sight gauges that improve safety by externally shielding the glass sight tube. Examples of prior art sight gauges are described in the following patents:

Kelada, U.S. Pat. No. 6,234,018 describes a safety liquid level sight gauge with a transparent sight tube coaxially disposed between mounting blocks and concentrically within a transparent shield tube which is protected by a metal sleeve with a sliding inspection window for observing the liquid level therein. The gauge includes a safety liquid level sight gauge with a transparent sight tube coaxially disposed between mounting blocks and concentrically within a transparent shield tube which is protected by a metal sleeve with a sliding inspection window for observing the liquid level therein. The gauge includes a sight tube breakage shut off system, and a leak shut off system. The breakage shut off system includes the transparent sight tube coaxially aligned between a pair of check valves within each mounting block. A check valve push rod is concentrically disposed and supported within the bore of the sight tube and urges both check valves to an open position allowing liquid to enter the bore of the sight tube. When the push rod collapses, such as when the sight tube is either cracked or broken, the check valve move to a closed position. The leak shut off system allows the check valves to move to a closed position when a pressure change occurs in the interstices formed between the transparent sight tube and the shield tube, the interstice is in communication with a diaphragm positioned on one end of a check valve activation plunger. The plunger is positioned between one end of the push rod and one check valve and moves perpendicularly to the push rod with a normal position that allows the push rod movement to be transferred to the check valve and a leak shut off position that allows the check valves to move to a closed position. A pressure change within the interstices influences the diaphragm to move the plunger to the leak shut off position closing the check valves.
Wolf, U.S. Pat. No. 5,648,607 describes a replaceable sight gauge assembly which includes two bolt assemblies. Each bolt assembly includes an entry bolt and an exit bolt, the entry bolt houses a valve which is opened when the exit bolt is mated therein, the valved bolts provide a means for replacing the sight gauge.
Sheridan, U.S. Pat. No. 5,628,231 describes a sight glass for steam boilers which includes and flanges provided with molded inserts which serve to provide sealing means engaging the end surface of a sight glass. A concentrically disposed guard tube is also maintained in sealed relation to the end flanges. Tie rods to prevent excess tightening of the ended flanges are also provided.
Mills, U.S. Pat. No. 5,442,159 describes a sight gauge positioned between two spaced apart compression fittings which receive an elongated tubular transparent tube shield and a slightly longer concentrically placed sight tube.
Newman, U.S. Pat. No. 5,323,654 describes a shielded sight glass positioned between two spaced apart confronting fitting which is shielded by a polygon impact resistant plastic enclosure.
Gruett, U.S. Pat. No. 5,323,653 concerns a method for mechanically supporting a shield for a liquid gauge. The apparatus includes a support member, first and second end blocks which are slidable engagable with the support member while each has a passage way, sealborne by each of the end blocks and disposed in each of the passage ways and a transparent tube telescopingly received in the respective passage ways and defining a fluid passage way or chamber.
Bertani, U.S. Pat. No. 5,383,360 describes a column type level indicator with a means for its outward mounting through fixing screws with axial and transverse holes there through which act as ducts into the sight tube.
Ford et al., U.S. Pat. No. 5,052,224 describes a shielded vertically mounted sight gauge with a transparent pipe extending between housings, while each housing includes a flange for receiving a larger transparent shielding pipe, one flange telescopingly receives the shield with a biasing means that urges against the shield pipe so that the flange can be moved away from the shield pipe and access gained to the sight tube.
Sheridan, et al. U.S. Pat. No. 4,838,095 describes a sight glass with sampling system and includes an inner transparent glass tube an outer concentric shield tube forming an interstices between the tubes and a drain for remaining leakage caused by fracture of the inner tube.
Mills, U.S. Pat. No. 4,693,117 describes a shielded tubular gauge for placement between two spaced apart fittings connected to a vessel to show the level of liquid in the vessel, including an elongated sheet of protective material slidable received in the U-shaped edges of the frame.
Jackson, U.S. Pat. No. 4,345,468 describes a level sight monitor which includes a double tube sight element. The internal glass element is connected to the liquid system being monitored. The external tube is transparent plastic and provides a protective shield to the internal pipe and is spaced apart from the internal tube with “O” rings fitted, preferably flanged inserts. The annulus between the two tubes can be environmentally purged.
Gruett, U.S. Pat. No. 3,886,796 describes a gauge for indicating liquid level in a tank with a transparent plastic tube disposed between a pair of hollow end members. a sight tube breakage shut off system, and a leak shut off system. The breakage shut off system includes the transparent sight tube coaxially aligned between a pair of check valves within each mounting block. A check valve push rod is concentrically disposed and supported within the bore of the sight tube and urges both check valves to an open position allowing liquid to enter the bore of the sight tube. When the push rod collapses, such as when the sight tube is either cracked or broken, the check valve move to a closed position. The leak shut off system allows the check valves to move to a closed position when a pressure change occurs in the interstices formed between the transparent sight tube and the shield tube, the interstice is in communication with a diaphragm positioned on one end of a check valve activation plunger. The plunger is positioned between one end of the push rod and one check valve and moves perpendicularly to the push rod with a normal position that allows the push rod movement to be transferred to the check valve and a leak shut off position that allows the check valves to move to a closed position. A pressure change within the interstices influences the diaphragm to move the plunger to the leak shut off position closing the check valves.

In today's industries, it is sometimes necessary to store large quantities of fluids in a large container. Since fluid is added and withdrawn, it is necessary to keep an accurate measurement of the amount of fluid within the container. In order to accomplish this task, a sight glass is often used. The level of the fluid is measured by an upper and lower inlet/outlet passageway which may be connected to a cylinder which may have a glass wall which may be calibrated to indicate the level of the fluid within the container. However, the glass is susceptible to breakage and leakage especially in an industrial situation. This could lead to a serious leakage of the fluid if left unchecked. However, a ball check valve has been employed in the upper and lower passageway which will seat in the passageway when the fluid begins to excessively flow in towards the sight glass. The ball check valve obstructs the flow of the fluid and prevents the leakage of the fluid.

Commonly, the ball check valve is used in conjunction with a gage cock valve which allows the user to restrict the flow of fluid to the sight glass. The method that is used to unseat the ball check for equalizing pressure between the vessel and the gage glass is unreliable. The operator is required to turn the valve wheel of the gage cock valve many rounds to seat the valve stem which pushes the ball off the seat slightly. Once the ball is off the seat, the operator can then slightly open the valve to create a slight gap for liquid to bypass the ball check. If the valve is open to far, the ball check will seat as a result of the flow of fluid.

Consequently, there is only a small margin for error. Problems can arise if one of the ports is slightly obstructed which frequently occurs because the ports are generally small. The gage cock valve frequently freezes up due to the exposed valve stem and internal plugging. Also, the gage cock valve is prone to leaks due to several sealing surfaces which results in costly repairs.

### SUMMARY

The present invention addresses these problems. The present invention includes a ball check device but provides an apparatus and method to bypass it by using an internal passageway in order to correct the problem of a plugged or stuck ball. The present invention increases port sizes in order to help prevent plugging.

The valve design of the present invention is less prone to freeze up because of the ball valve design. The present invention does not include an exposed stem to help prevent the valve from freezing or sticking due to external corrosion. The valve of the present invention is easier to operate because the handle turns a short distance. The pressure between the vessel and the gage glass can be equalized by simply turning the handle a short distance to allow the fluid to flow in a bypass passageway in order for the pressure to equalize. Once the pressure has been equalized, the ball check should unseat, and the handle can be turned back to the safety ball check position.

The present invention could be used when placing a new gage glass, while repairing the gage glass or a glass that has been drained in service and repairing the gage glass or a gage glass which has been drained while in service. The present invention is useful in determining if the vessel tap is plugged or if the ball check port is plugged.

Fluid could be allowed to flow through the gage glass by opening a bleeder valve on the gage glass by opening the bypass passageway around the ball check. If the fluid flows, than the user can determine that the vessel tap is not plugged and that the level in the glass is accurate. If the level becomes unreliable once the valve is switched to the ball check position, the user can determine if the ball check is plugged or stuck. Level verification can still be obtained by switching back to the bypass passageway. The present invention is less likely to leak due to the ball valve type design and less sealing surfaces. The sealing surfaces are more reliable and proven.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the valve of the present invention in a first position;

FIG. 2 illustrates a cross-sectional view of the valve of the present invention in a second position;

FIG. 3 illustrates a cross-sectional view of the valve of the present invention in a third position;

FIG. 4 illustrates a side view of the valve of the present invention;

FIG. 5 illustrates a cross-sectional view of the vessel, sight glass and valve of the present invention

FIG. 6 illustrates another cross-sectional view of the vessel, sight glass and valve of the present invention;

FIG. 7 illustrates a cross-sectional view of the vessel and valve with the sight glass removed.

FIG. 8 illustrates a perspective view of the valve of the present invention;

FIG. 9 illustrates a cross-sectional view of the valve of the present invention;

FIG. 10 illustrates a perspective view of the valve of the present invention;

FIG. 11 illustrates a cross-sectional view of the valve of the present invention;

FIG. 12 illustrates a perspective view of a side mount of the valve of the present invention;

FIG. 13 illustrates a perspective view of the vessel, sight glass and valve of the present invention;

FIG. 14 illustrates a perspective view of the vessel, sight glass and valve of the present invention;

FIG. 15 illustrates a perspective view of the valve of the present invention;

FIG. 16 illustrates a perspective view of the valve of the present invention mounted on the flange;

FIG. 17 illustrates a cross-sectional view of the valve of the present invention;

FIG. 18 illustrates a perspective view of a top and bottom mount of the valve of the present invention;

FIG. 19 illustrates a cross-sectional view of the top and bottom mount of the valve of the present invention;

FIG. 20 illustrates a cross-sectional view of the valve of the present invention;

FIG. 21 illustrates a cross-sectional view of the vessel, sight glass and valve of the present invention;

FIG. 22 illustrates a perspective view of the vessel, sight glass and valve of the present invention;

FIG. 23 illustrates a perspective view of the vessel, sight glass and valve of the present invention.

### BRIEF DESCRIPTION

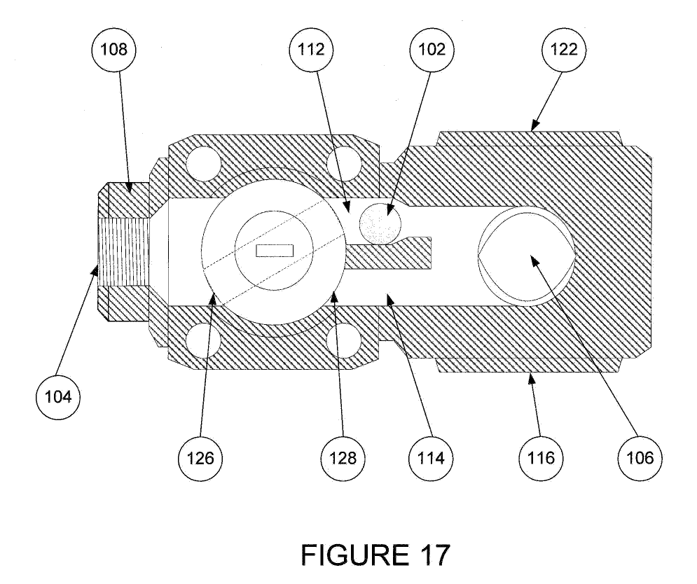

FIG. 17 illustrates a cross-sectional view of the valve of the present invention. FIG. 17 shows an internal thread 116 for connection to the sight glass 118, internal thread 122 for connection to the bleeder valve, output port 106 for the valve which is input to the sight glass, and ball check 102 which is positioned in the ball check passageway 112. The ball check passageway 112 extends from the outlet 106 to the inlet of the rotatable passageway 126 and is substantially parallel to a bypass passageway 114 which extends from the outlet 106 to the inlet of the rotatable passageway 126. The rotatable passageway 126 can be turned by the user and extends from either the ball check passageway 112 or from the bypass passageway 114 to the liquid inlet 104 of the valve. When the rotatable passageway 126 is turned to the ball check passageway 112, the bypass passageway 114 is blocked by the blocking cylinder 128. When the rotatable passageway 126 is turned to the bypass passageway 114, the ball check passageway 112 is blocked by the blocking cylinder 128. The rotatable passageway 126 connects the liquid inlet 104 with the liquid outlet 106.

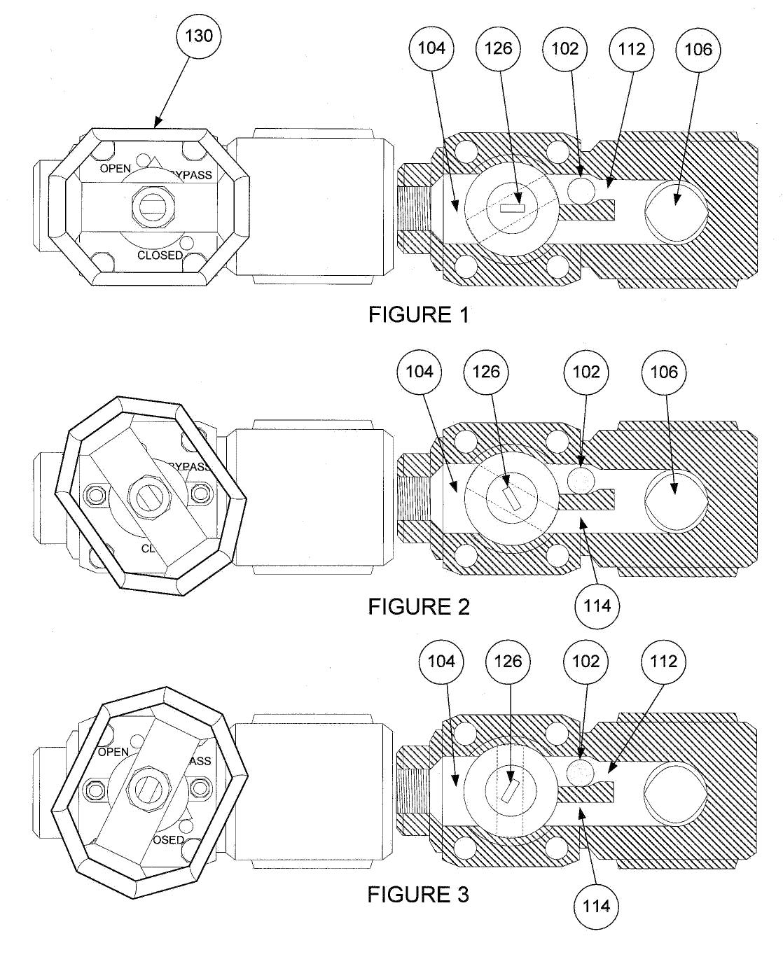

FIG. 1 illustrates a valve handle 130 set in the open position which turns the rotatable passageway 126 to connect the liquid inlet 104 with the ball check passageway 112 which includes the ball check 102 so that liquid can flow from the liquid inlet 104 to the ball check passageway 112 and to the liquid outlet 106 and flow to the sight glass 118.

FIG. 2 illustrates the valve handle 130 set in the bypass position which turns the rotatable passageway 126 to connect the liquid inlet 114 with the bypass passageway 114 so that liquid can flow from the liquid inlet 114 to the liquid outlet 106 without passing the ball check 102.

FIG. 3 illustrates the valve handle 130 in a closed position which turns the rotatable passageway 126 so that neither the bypass passageway 114 or the ball check passageway 112 is connected to the liquid inlet 104.

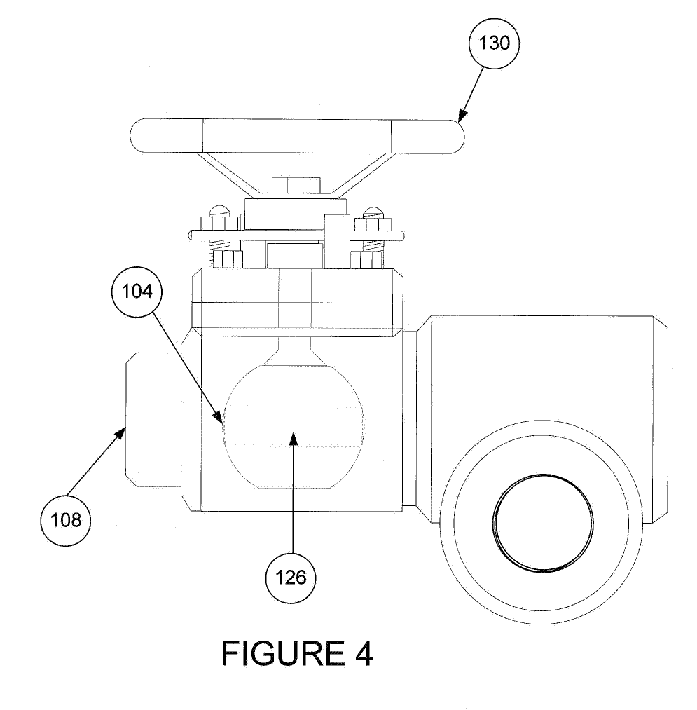

FIG. 4 illustrates the internal threads 108 to the flange, the valve handle 130, and the liquid inlet 104.

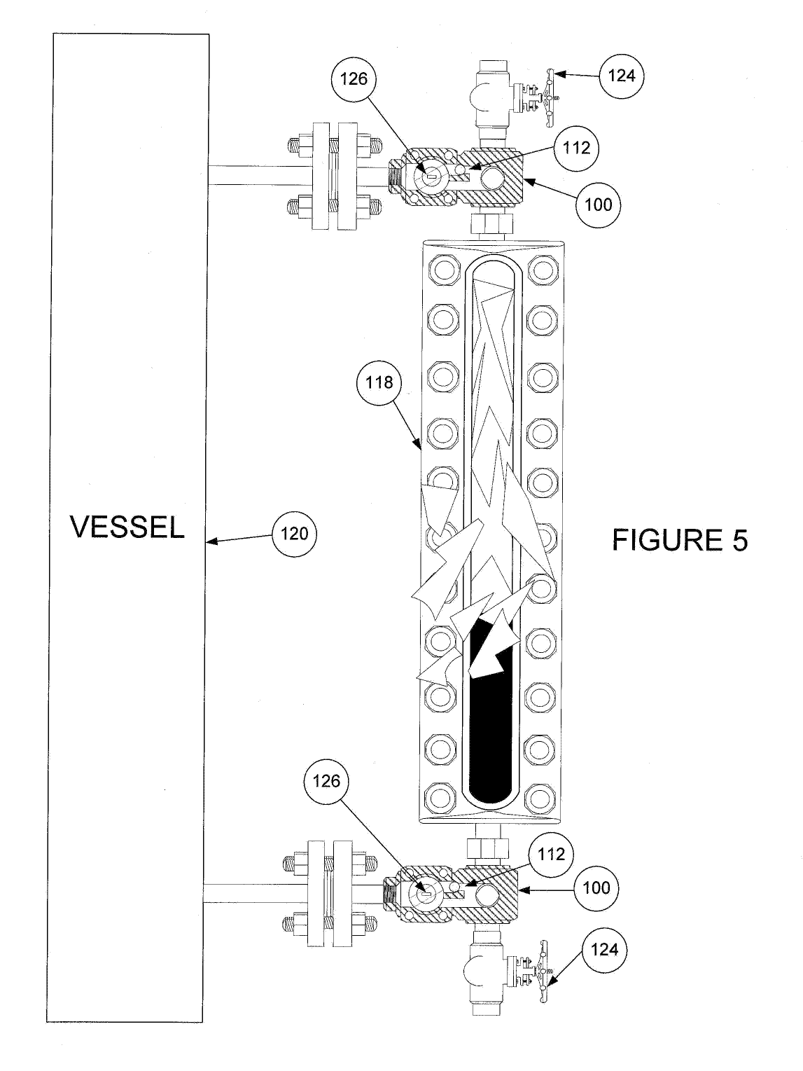

FIG. 5 illustrates a pair of the valves 100 connected at respective ends of a sight glass 118 for a vessel 120. Both of the valves 100 show the rotatable passageway 126 connected to the ball check passageway 112, and as a consequence, if the sight glass 118 should break or leak, the ball check 102 in both the valves 100 would seat preventing liquid from spilling. FIG. 5 additionally illustrates a bleeder valve 124 connected to the valve 100.

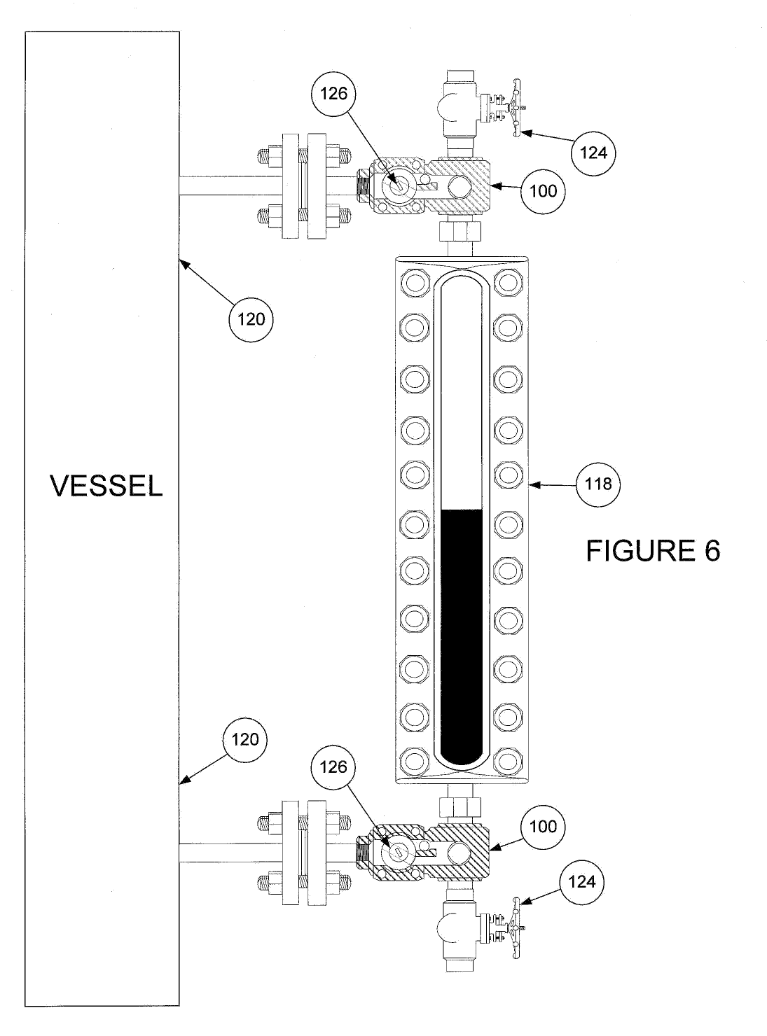

FIG. 6 illustrates the fluid within the sight glass 118 been equalized with respect to the fluid within the vessel 120. The rotatable passageway 126 has been rotated to connect the bypass passageway 114 to the liquid inlet 104 so that the ball check 102 can not interfere with the flow of the liquid into the sight glass 118.

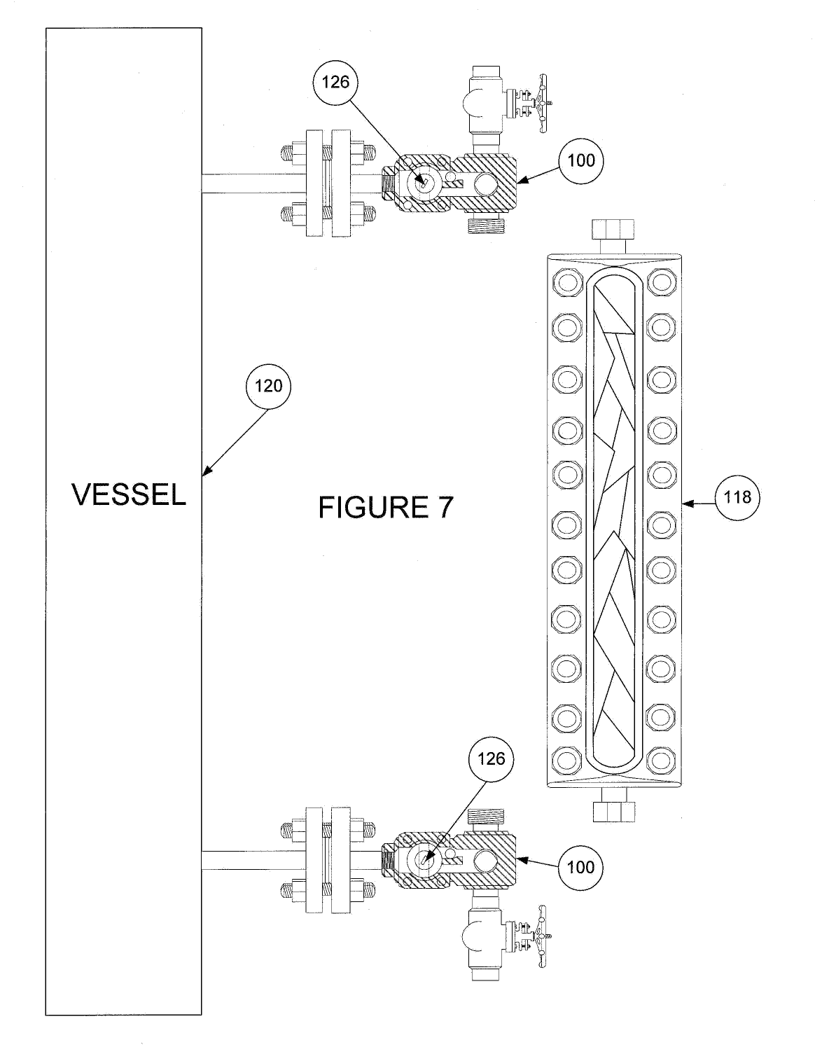

FIG. 7 illustrates the valve 100 which has been disconnected from the sight glass 118 and illustrates that the rotatable passageway 126 has been rotated so that there is no connection between the liquid inlet 104 and the ball check passageway 112 and the bypass passageway 114. Consequently, the valve 100 is closed.

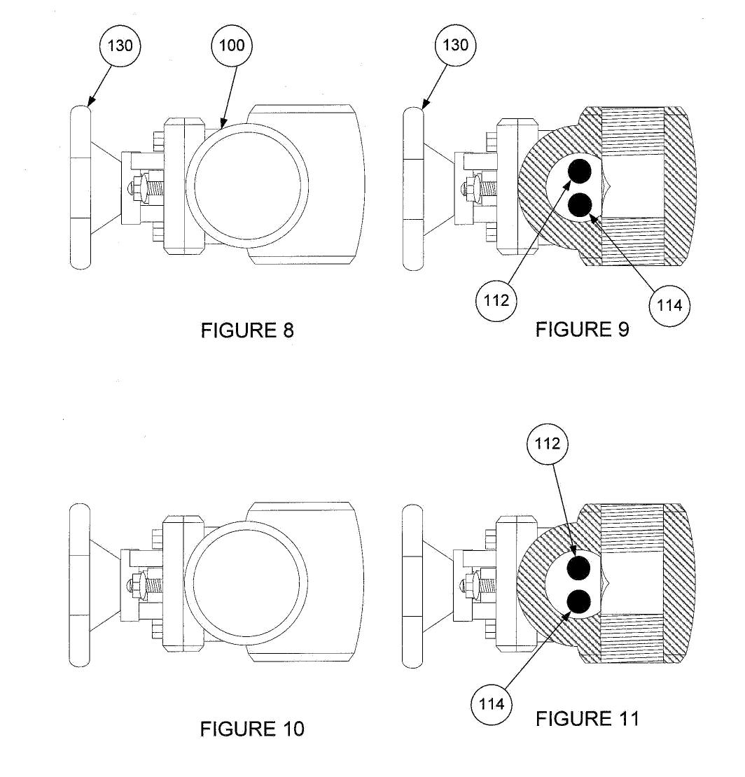

FIG. 8 illustrates a perspective view of the end of the valve 100.

FIG. 9 illustrates a cross-sectional view of the valve 100 of the present invention. FIG. 9 illustrates the ball check passageway 112 and the bypass passageway 114.

FIG. 10 illustrates a perspective view of the valve 100.

FIG. 11 illustrates a cross-sectional view of the valve 100 of the present invention. More particularly, FIG. 11 illustrates the ball check passageway 112 and the bypass passageway 114.

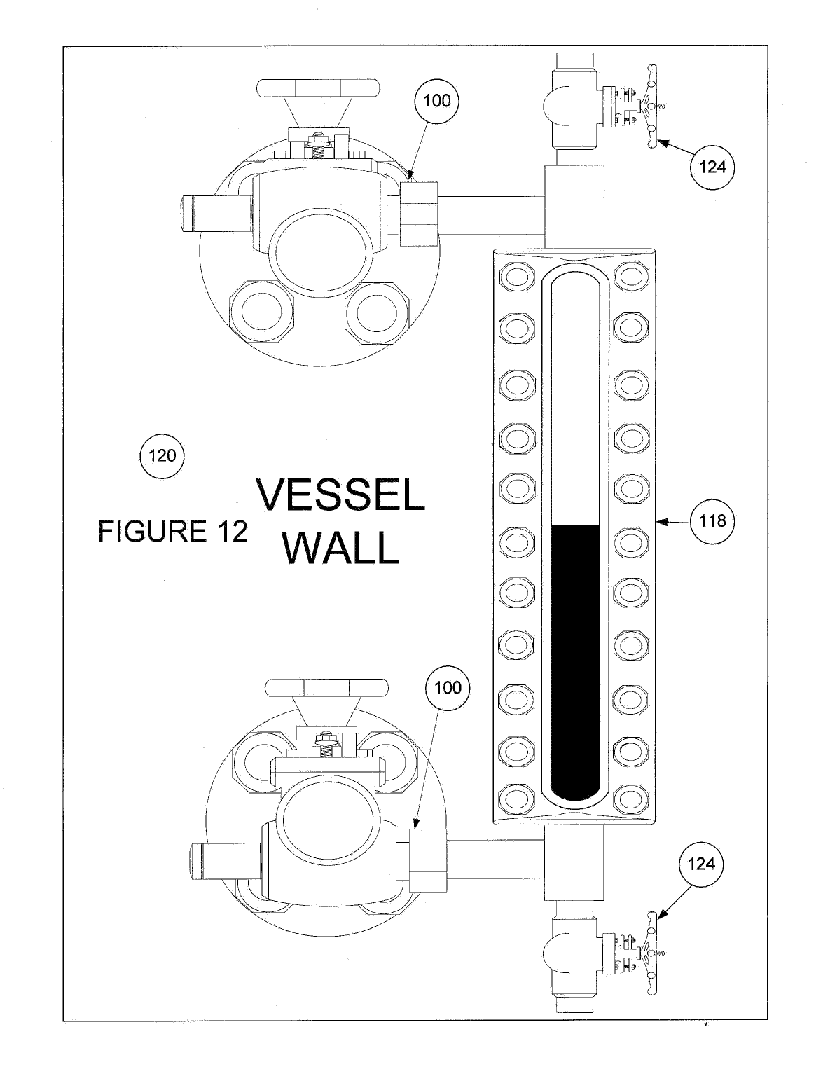

FIG. 12 illustrates a perspective view of the valve 100 connected to the sight glass 118 and the vessel 120. FIG. 12 additionally illustrates the bleeder valve 124 connected to the valve 100.

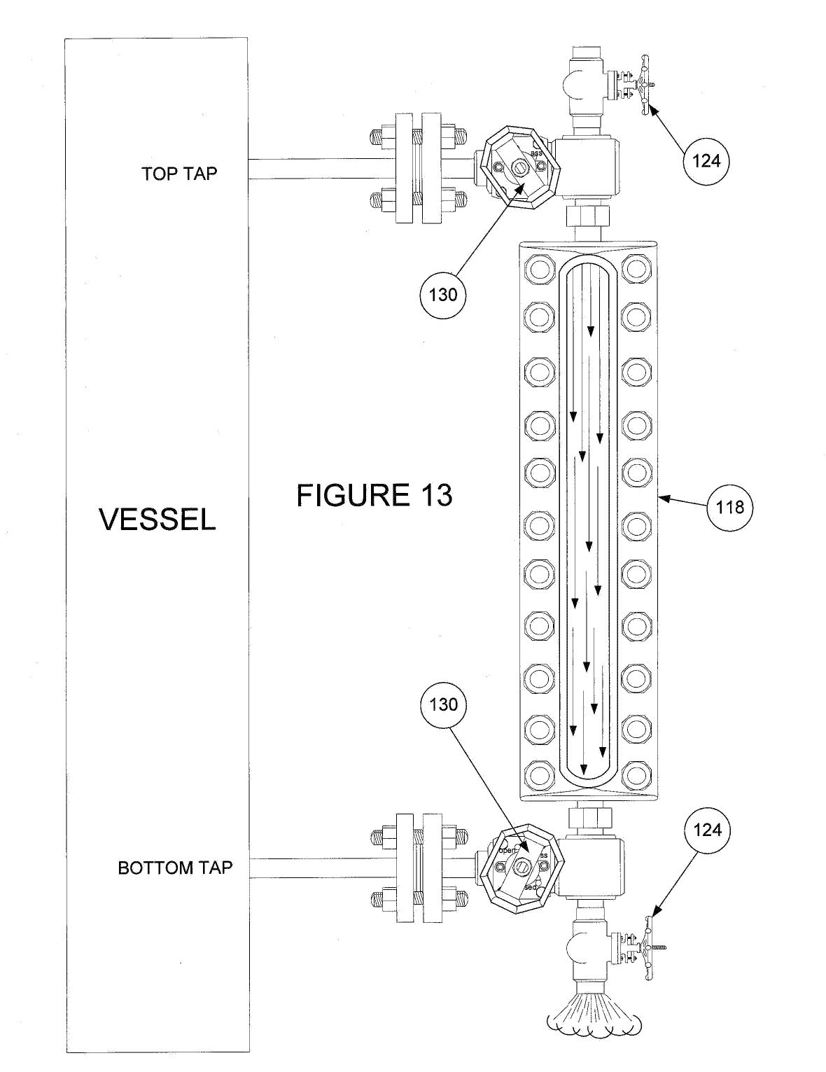

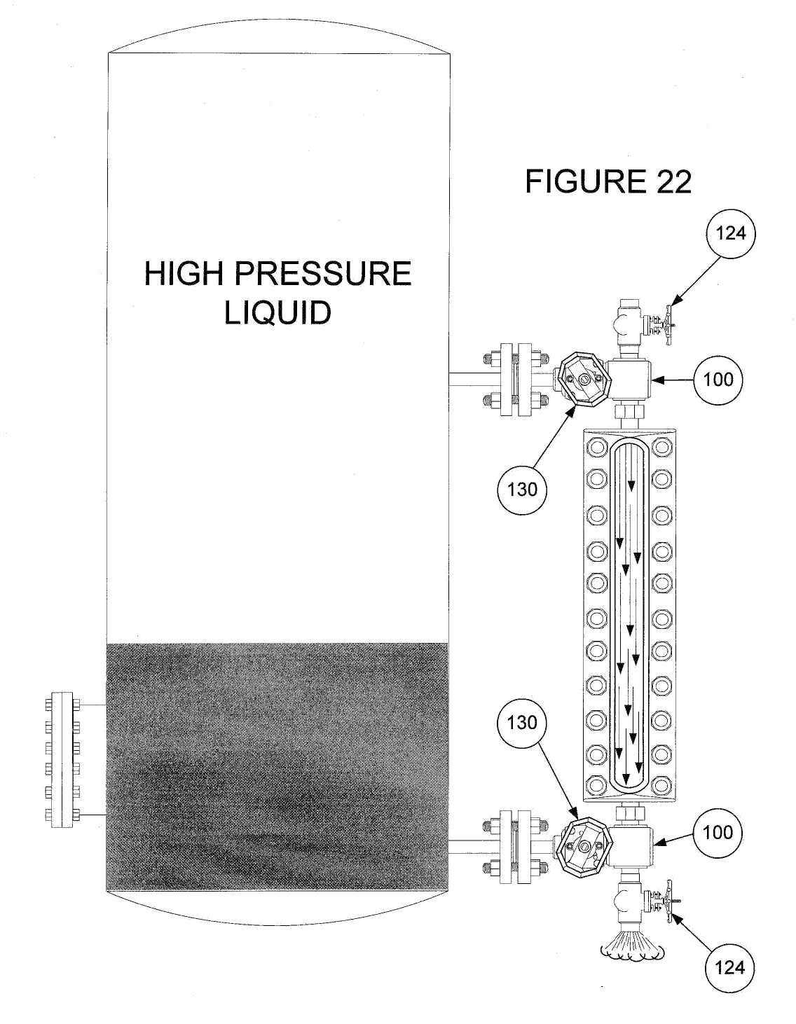

FIGS. 13 and 22 illustrate the operation of the valve 100 to determine if the top tap is clear of pluggage. The top valve 100 is placed in a bypass mode such that the rotatable passageway 126 connects the liquid inlet 104 and the bypass passageway 114 and the bottom valve 100 is placed in a closed mode so that the rotatable passageway 126 does not connect the liquid inlet 104 with the ball check passageway 112 or the bypass passageway 114. Furthermore, the top bleeder valve 124 is closed, and the bottom leader valve 124 is open. If vapor is allowed to flow through the bottom bleeder valve 124 then the top tap is clear. Reversing the top for the bottom checks the bottom valve 100.

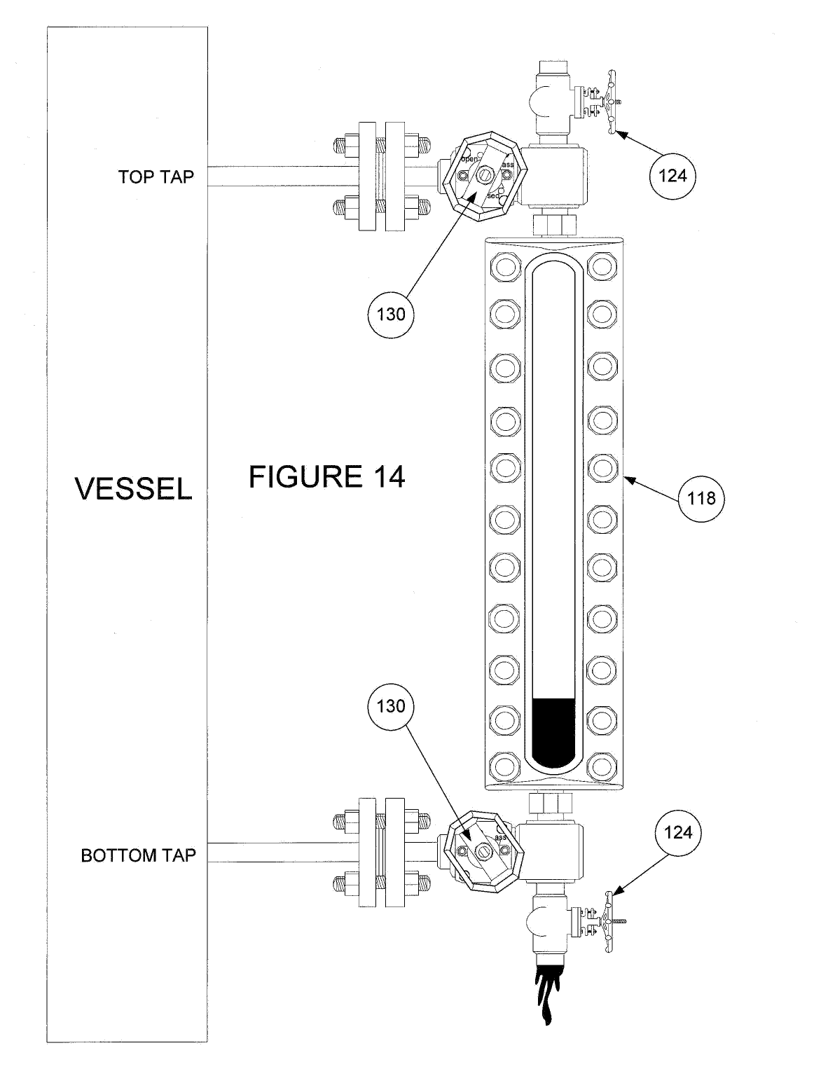

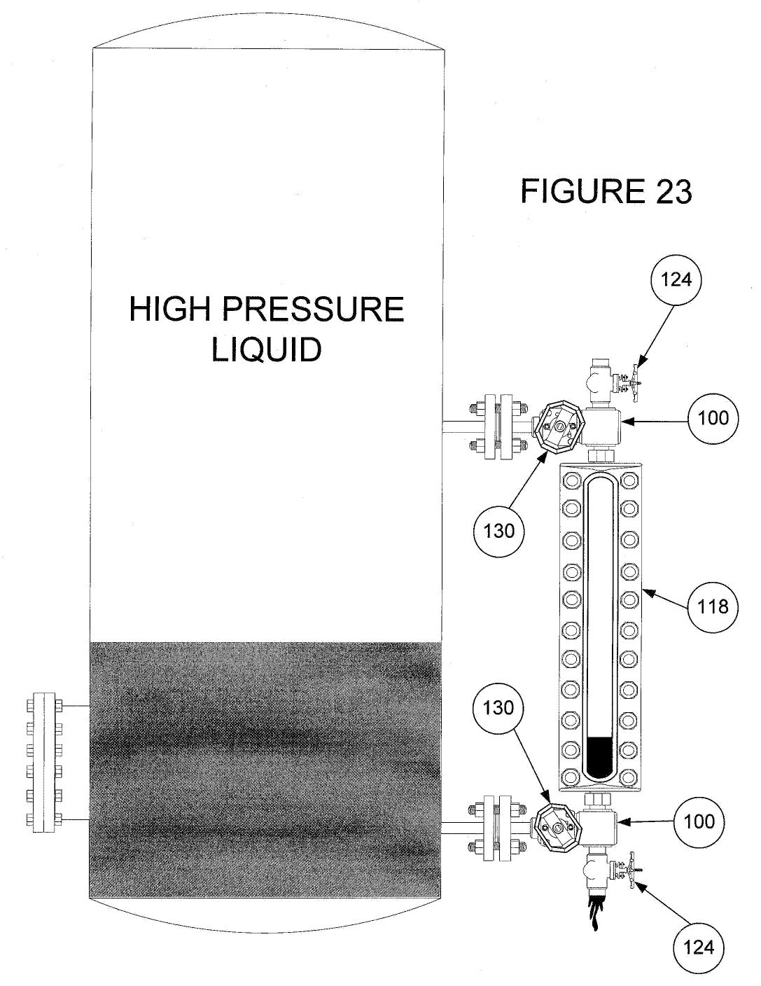

FIGS. 14 and 23 illustrate the operation of the valve 100 to determine if the bottom tap is clear of pluggage. The top valve 100 is placed in a closed mode such that the rotatable passageway 126 does not connect the liquid inlet 104 with the ball check passageway 112 and the bypass passageway 114, and the bottom valve 100 is placed in a bypass mode so that the rotatable passageway 126 connects the liquid inlet 104 with the bypass passageway 114. Furthermore, the top bleeder valve 124 is closed, and the bottom bleeder valve 124 is open. If liquid is allowed to flow through the bottom bleeder valve 124 then the bottom tap is clear. Reversing the top for the bottom checks the top tap.

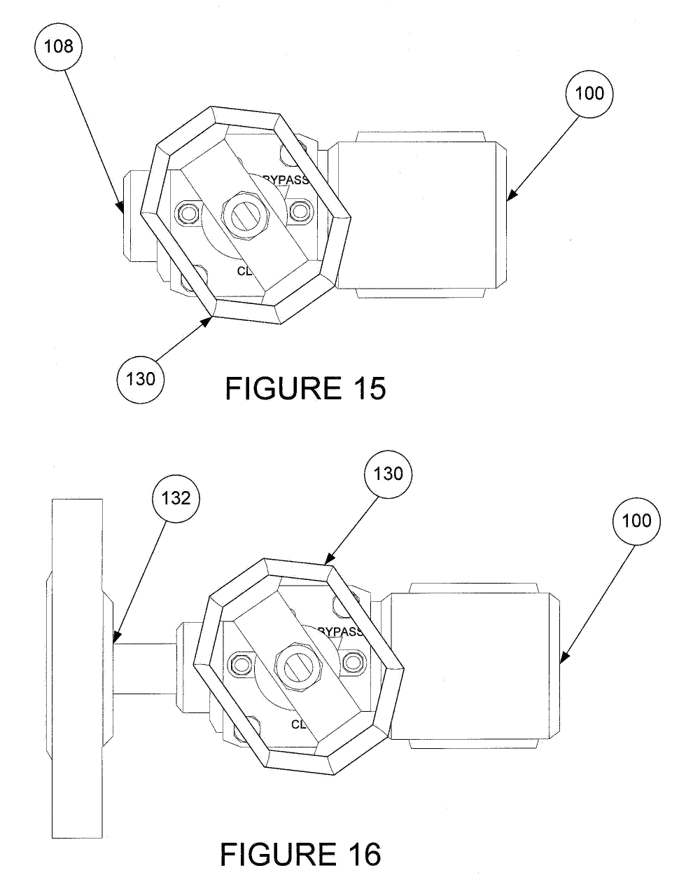

FIG. 15 illustrates the internal threads 108 of the valve 100 to be connected to the threaded flange 132.

FIG. 16 illustrates the threaded flange 132 connected to the valve 100.

FIG. 17 illustrates a cross-sectional view of the valve as described above.

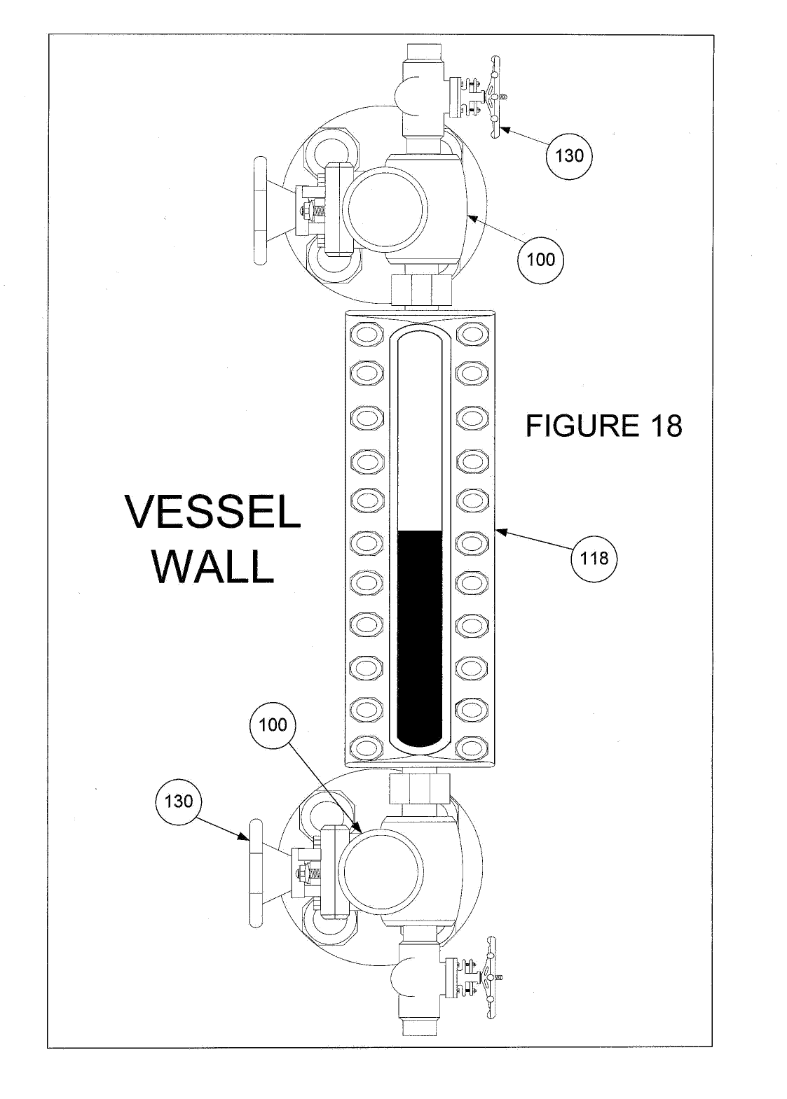

FIG. 18 illustrates a perspective view of a top mount and a bottom mount for the valve 100 which is mounted on the sight glass 118.

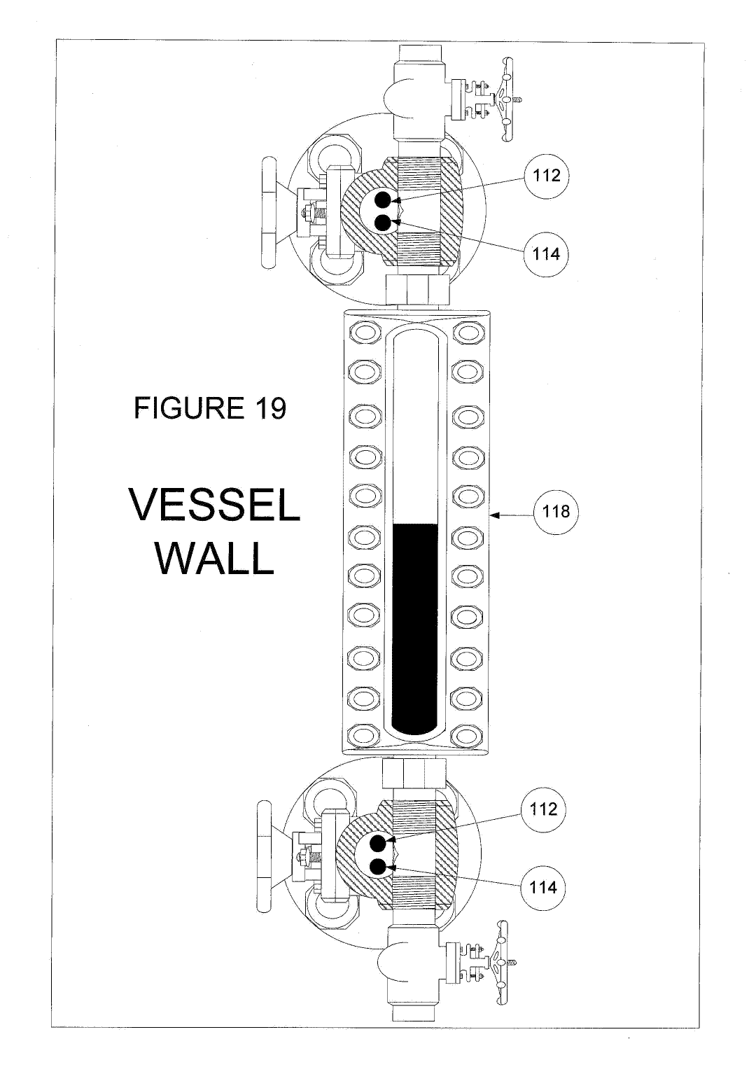

FIG. 19 illustrates a cross-sectional view of a top mount and a bottom mount for the valve 100 which is mounted on the sight glass 118. FIG. 19 additionally illustrates the ball check passageway 112 and the bypass passageway 114.

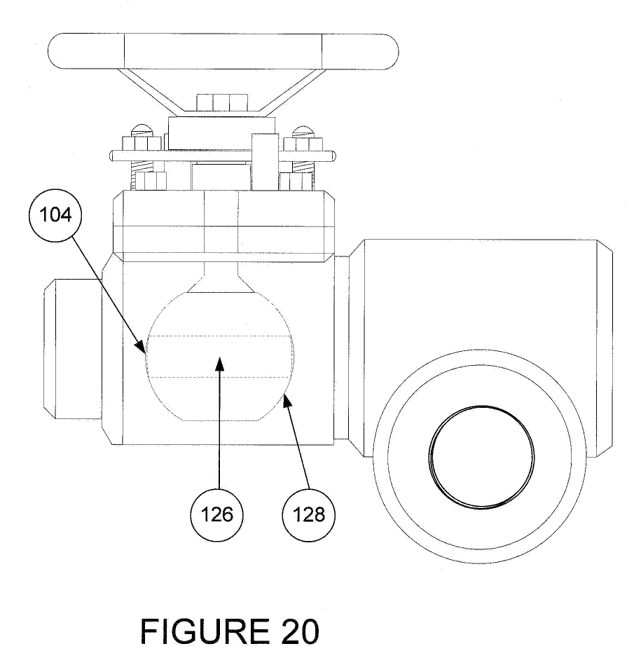

FIG. 20 illustrates a cross-sectional view of the valve 100 of the present invention and illustrates the liquid inlet 104, the blocking cylinder 128 and the rotatable passageway 126.

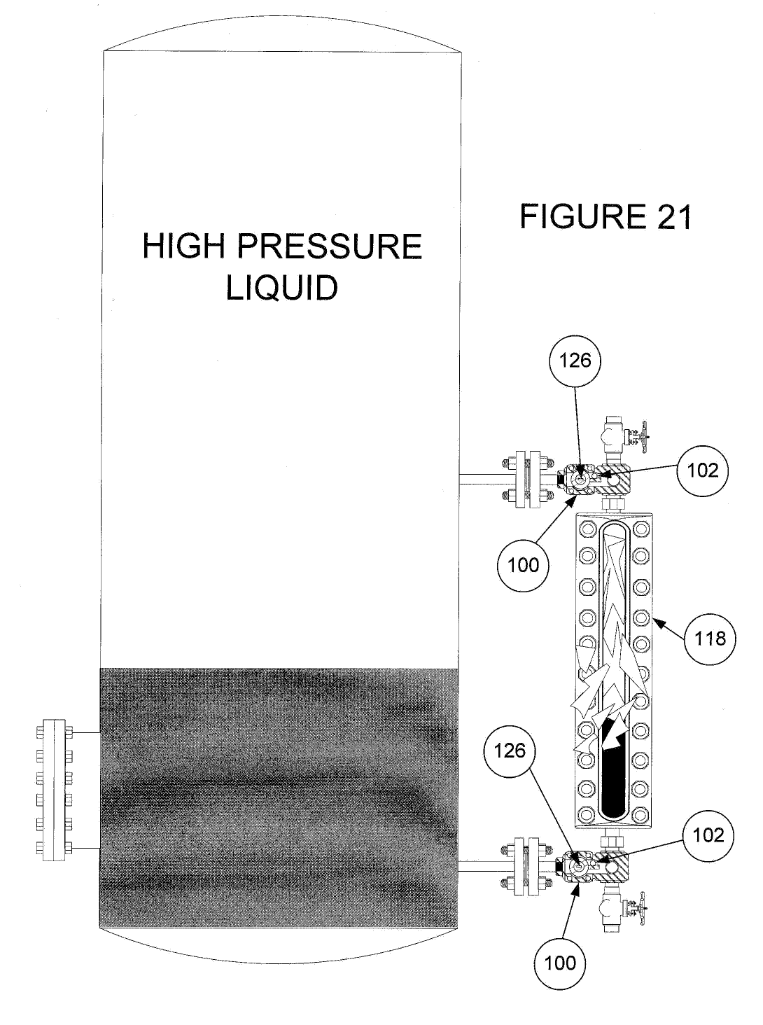

FIG. 21 illustrates that the ball check 201 seats in response to the breakage of the sight glass 118. The rotatable passageway 126 is shown as being connected to the ball check passageway 112.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An apparatus for measuring the level of fluid in a vessel, comprising:
a sight glass for showing the level of the fluid;
a valve including:
a ball valve passageway having a ball check;
a bypass passageway for bypassing the ball check;
a rotatable passageway for selecting the ball check passageway or the bypass passageway.

2) An apparatus for measuring the level of fluid in a vessel as in claim 1, wherein said valve includes a fluid inlet.

3) An apparatus for measuring the level of fluid in a vessel as in claim 1, wherein said valve includes an outlet for connection to the sight glass.

4) An apparatus for measuring the level of fluid in a vessel as in claim 1, wherein the apparatus includes a bleeder valve.

5) An apparatus for measuring the level of fluid in a vessel as in claim 1, wherein the valve includes a blocking cylinder to block the ball check passageway or the bypass passageway.

6) A system for measuring the level of fluid in a vessel, comprising:
a sight glass for showing the level of the fluid;
a valve including:
a ball valve passageway having a ball check;
a bypass passageway for bypassing the ball check;
a rotatable passageway for selecting the ball check passageway or the bypass passageway.

7) A system for measuring the level of fluid in a vessel as in claim 6, wherein said valve includes a fluid inlet.

8) A system for measuring the level of fluid in a vessel as in claim 6, wherein said valve includes an outlet for connection to the sight glass.

9) A system for measuring the level of fluid in a vessel as in claim 6, wherein the apparatus includes a bleeder valve.

10) A system for measuring the level of fluid in a vessel as in claim 6, wherein the valve includes a blocking cylinder to block the ball check passageway or the bypass passageway.
